(19) United States
(12) Patent Application Publication
(10) Pub. No.: US 2009/0025034 A1
(43) Pub. Date: Jan. 22, 2009

(54) Personal television guide

(76) Inventors: Tessa Modiri, Baltimore, MD (US); Edgar Raojabli, Baltimore, MD (US)

Correspondence Address: TESSA MODIRI, 100 HARBORVIEW RD., APT # 2303, BALTIMORE, MD, 21230, US

(21) Appl. No.: 11/778,356

(22) Filed: Jul. 16, 2007

(51) Int. Cl. G06F 3/00

(52) U.S. Cl. 725/43

(57) ABSTRACT

This is a method to use an individual's specific interests to appropriately select for television programming that matches these interests. Once the matching television programming is found, the individual is then notified through any number of communication means of upcoming matching television programming, ensuring that the individual never has to sit and flip through channels to find something they like and further never miss a television program that matches their interest.

### BACKGROUND OF THE INVENTION

Individuals use television listings to decide what to watch on television. Knowing where and when to find a program one is interested in is critical to enjoying television in a world of hundreds of channels available today through typical cable, satellite or internet-tv providers. However, this is not easily achieved with technology that is available today. Current “television guides” in paper form are not searchable by electronic means, therefore it is impossible to find the necessary information unless one spends hours perusing each page of the guide. Current “television guides” in electronic form, also known as “Electronic Program Guide” do not solve this issue either, as it they are searchable only by the name of the television program and not be description. While descriptions are available, since they are not organized by keywords and are not searchable, valuable viewing time is lost looking through each description of each program that one might be interested in to see if it is indeed a program that matches one's interests. In the world of cable and satellite programming which often provides several hundred channels of entertainment, it is indeed impossible to have any good idea of what is available for viewing at any given time. Thus, at the present time, television viewing is limited by the inability to match one's personal interest to television programming in an efficient, time-saving and consistent manner.

### BRIEF SUMMARY OF THE INVENTION

The invention is a process which facilitates decision-making for television viewers. It is a process whereby all television programming content is catalogued and tagged. The invention solves the problem of having hundred of channels and having to flip through all of them to see what's on. Additionally, it provides notification to the user of upcoming television programming that exactly matches their indicated interests.

### BRIEF DESCRIPTION OF THE DRAWINGS

The foregoing summary and the following detailed description are better understood when read in conjunction with the appended drawings. For the purpose of illustrating the invention, like reference numerals represent similar parts throughout the several drawings, it being understood, however, that the invention is not limited to the specific methods and instrumentalities disclosed. In the drawings:

FIG. 1 is a block diagram of a database of television programming wherein each program is described with descriptive tags

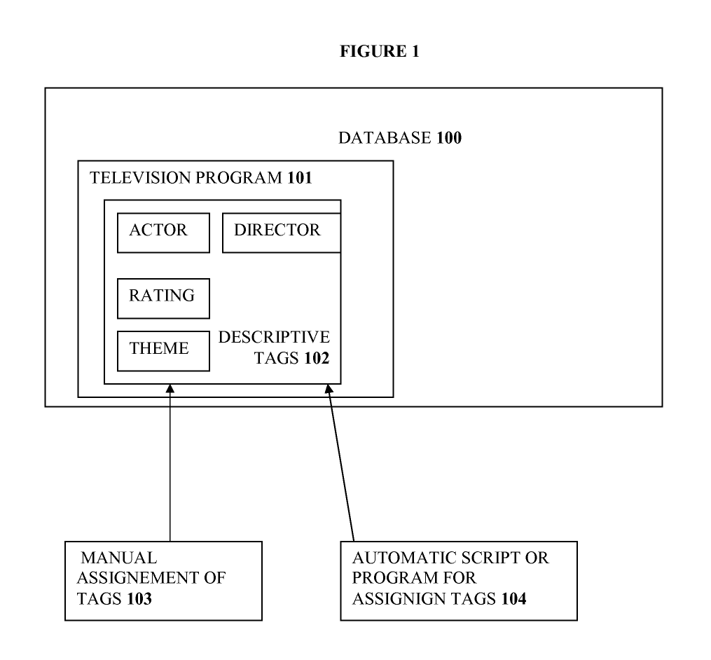

FIG. 2 is a lock diagram of a search script enabling the user to search the database for descriptive tags that match his interest and obtain a result of appropriate television programs.

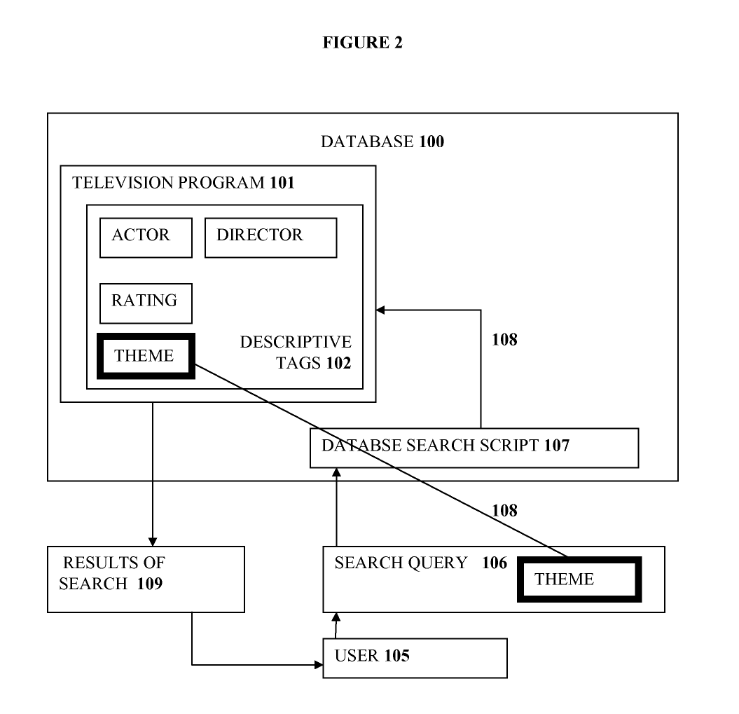

FIG. 3 is a block diagram of an “alert service” which uses current television listings and programs matching user keyword queries through their tags to notify the user when such a program will be on the air in their coverage area and on their specific television provider.

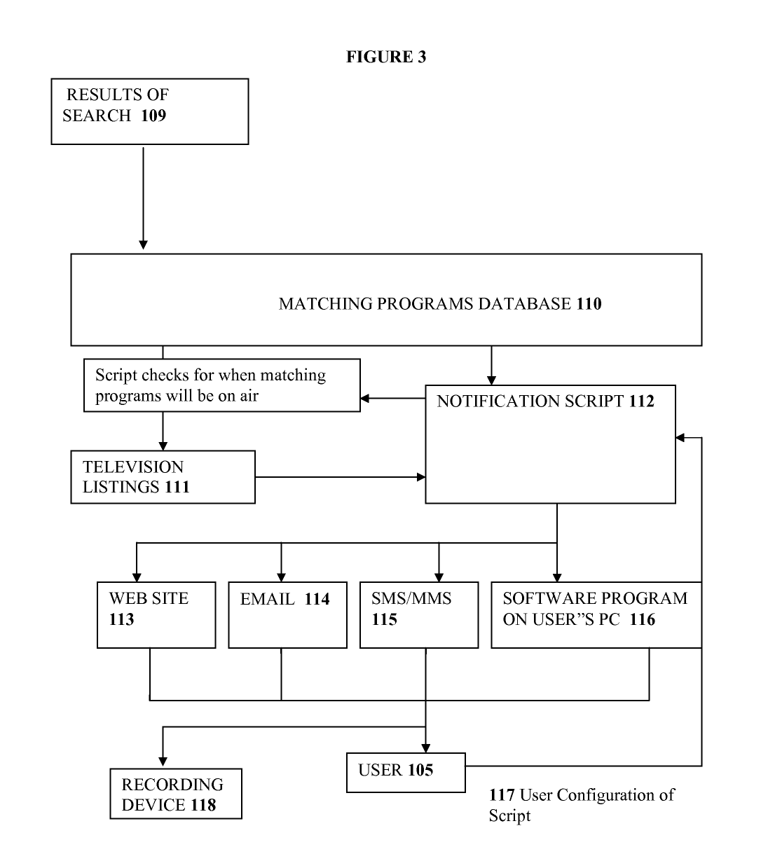

### DETAILED DESCRIPTION OF THE INVENTION

The invention comprises the following parts:

A database 100 of all available television programming, where each individual television program 101 (film, show, sports event, series sitcom etc) is tagged with searchable keywords 102 for the following categories (not limited): theme, actors, location, producer, time period, language, culture, television-rating etc. These tags can be in any number of currently available web or programming languages, such as Hypertext Markup Language (HTML), Extensible Markup Language (XML), cgi, ASPX etc and stored in any appropriate format, such as database. The assigning of the tags may be done manually 103, or may be done automatically 104 through any means currently available, or to be developed in the future.

Examples of theme: “world war II” “reality television” “cooking” “financial advice” “wimbledon final” “mafia” etc

Themes can then be narrowed by selecting sub-themes: Theme=cars, sub-theme=antiques, repair, racing, auction, history, making etc. . . .

Actor includes: actor credited in a film or series, person appearing on a talk show, athlete involved in a sporting event.

A web site script or computer program 107, again in any suitable web or computer programming language currently available or to be developed, that will allow a user 105 to select their interests, to obtain a result 109 from the database of all television programs whose descriptive tags match their criteria using a matching algorithm or script 108. For example, a user selecting “Edward Norton” as an actor, and selecting PG-13 as their desired television-rating (so they can, for example, watch their favorite actor with the kids), would get “Keeping the Faith” as a result, but not “American History X”, which is a film intended for mature audiences and carries a TV-M rating. Furthermore, this same search would return not only films in which Edward Norton acted, but also, for example, an episode of the “Jay Leno Show” on which Edward Norton was a guest. The searchable database and tags are updated as frequently as possible to ensure accuracy and best user experience.

The third part of the invention is a script, program or other automated means of “alert service”, which when setup by the user according to their parameters 117 (any combination of keywords “tags”, time of day, channel etc) will, through a notification script or program 112 notify the user when their desired television programming (as specified by the results of search 109 stored in the “matching programs database” 110 will be available by consulting a database of TV listings 111 specific for the user's coverage air and television service provider. This allows the user to be notified of programs according to their interest, without knowing the exact name of the program. For example, a user specifying Peyton Manning as an “actor”, will be notified of all American football games where the athlete Peyton Manning is playing, as well as talk shows on which he is featured as a guest. Such a notification will be either on the website 113, program 116 or proprietary system on which the database and search is based, or can be through any other means including but not limited to email 114, instant messaging, Short Message System (SMS), Multimedia Message System (MMS) 115 which includes pictures and/or clips of television programming of which the user is notified) or other message software, hardware or means to be developed in the future. The notification may further be integrated with existing or future software or hardware 118 (Media Center PC, TiVo, etc) for the purpose of recording the television programming of interest. The alert service will use publicly available television listings or licensed television listings in a format searchable by the program, script or other automated means for the purpose of knowing when the specific program the user has requested through the search will be available on the user's television. The television listings will encompass all US television providers, including cable, “on demand”, over the air, satellite, fiber optic and IPTV and be specific to each user's coverage area which the user will indicate by providing their zip code when setting up the alert service 117.

The invention is presented for use to the consumer through several means. It can be operated as an internet website, a stand alone PC or Macintosh application, a “widget” for PC or Macintosh operating system, an embeddable Extensible Markup Language (XML)/Java/ActiveX or any other programming language “applet” component that may be embedded into any website, such as a portal website. Further it can be integrated into proprietary hardware, such as a cable box or the television itself. Therefore, the invention may be programmed in any programming language or standard, including any language or standard developed in the future, suitable for the platform (website, computer, phone etc) that it is being presented on.

I claim:

1. A method of describing television programming, including but not limited to cable, satellite, over the air, on demand and internet (IPTV) television, by assigning descriptive “keyword tags” to include but not limited to theme, actor, director, time period, location, language, culture, television-rating etc, whereby each television program has any number of such tags, describing each appropriate aspect of the program.

2. A method of assigning, storing and searching descriptive “keyword tags”, as in claim 1, wherein said tags are assigned using a script or computer program written in a programming language including, but not limited to Hypertext Markup Language (HTML), Extensible Markup Language (XML), JavaScript, C++ or any other programming means to be developed in the future.

3. A method of assigning, storing and searching descriptive “keyword tags”, as in claim 1, wherein said tags are assigned and stored using a proprietary system or proprietary programming language, including but not limited to, proprietary hardware-based system, such as a cable box, “stand alone” computer, television or other device, now available or to be developed in the future.

4. A method of assigning descriptive tags as in claim 1, wherein the tags are assigned manually by looking at each television program, understanding its contents and tagging each appropriate aspect of the television program.

5. A method of assigning descriptive tags as in claim 1, wherein the tags are assigned automatically by an algorithm, script, distributed computing or other method currently existing or to be developed in the future.

6. A method of assigning descriptive tags as in claim 1, wherein an additional “suggested” tag may be generated by users of the service who list their favorite shows or films to create recommendations for others.

7. A method of searching the descriptive tags assigned in the process described in claim 1, wherein the user of the service inputs a search parameter or combination thereof, to include but not limited to: theme, actor, director, time period, location, language, culture, television-rating etc to obtain a list of television programs that match his search criteria through the assigned keyword “tags”.

8. A method of searching the descriptive tags as in claim 7, wherein said tag database is searched using a script or computer program written in a programming language including, but not limited to Hypertext Markup Language (HTML), Extensible Markup Language (XML), JavaScript, C++ or any other programming means to be developed in the future.

9. A method of searching the descriptive tags as in claim 7, wherein said tag database is searched using a proprietary system or proprietary programming language, including but not limited to, proprietary hardware-based system, such as a cable box, computer box, television or other device, now available or to be developed in the future.

10. A method where a user of the service searches the descriptive tags as in claim 7, and additionally setup reminders to be notified at what time and at on what channel a show matching their searched “tags” will be playing, without having to know the specific name of the television program.

11. A method of notifications as in claim 10, wherein the notifications are available for viewing on a website or in the program sent via email, instant messaging service, Short Message Service (SMS), Multimedia Message Service (MMS) to include picture, video and sound or other message software, hardware or means to be developed in the future, including proprietary hardware systems.

12. A method of notification as in claim 10, wherein the reminder service is created and executed using a script or computer program written in a programming language including, but not limited to Hypertext Markup Language (HTML), Extensible Markup Language (XML), JavaScript, C++ or any other programming means to be developed in the future.

13. A method of notification as in claim 10, wherein the reminder service is created and executed using a proprietary system or proprietary programming language, including but not limited to, proprietary hardware-based system, such as a cable box, computer box, television or other device, now available or to be developed in the future.

14. A method of notification as in claim 10, wherein the user determines the manner and frequency in which they want to receive notifications in the manner as in claim 10.

15. A method of notification as in claim 10, wherein additionally the notification is integrated with currently available or future software or hardware, including but not limited to Windows Media Center, TiVo, DVR, for the purpose of recording the television programming that the user is notified of.
